(19) United States
(12) Patent Application Publication
(10) Pub. No.: US 2025/0153243 A1
(43) Pub. Date: May 15, 2025

(54) SOFT MAGNETIC ALLOY POWDER AND ELECTRONIC COMPONENTS INCLUDING THE SAME

(71) Applicant: SAMSUNG ELECTRO-MECHANICS CO., LTD., Suwon-si (KR)

(72) Inventors: Sangkyun Kwon, Suwon-si (KR); Jihye Kim, Suwon-si (KR); Jongho Chung, Suwon-si (KR); Iljin Park, Suwon-si (KR)

(73) Assignee: SAMSUNG ELECTRO-MECHANICS CO., LTD., Suwon-si (KR)

(21) Appl. No.: 18/903,547

(22) Filed: Oct. 1, 2024

(30) Foreign Application Priority Data
Nov. 9, 2023 (KR) 10-2023-0154862

(51) Int. Cl. B22F 1/16; H01F 1/153; H01F 27/29

(52) U.S. Cl. CPC B22F 1/16; H01F 1/15333; H01F 27/292; B22F 2301/15; B22F 2301/35; B22F 2302/25

(57) ABSTRACT

A soft magnetic alloy powder includes a core including an amorphous phase Fe—Co alloy or a Fe—Co alloy in which an amorphous phase and a nanocrystalline phase are mixed and a first coating layer disposed to surround the core and including a Co oxide, wherein Co is included in an amount of 5 atom % to 25 atom % in the entire Fe—Co alloy, and an amorphous rate of the soft magnetic alloy powder is 95% or more.

### CROSS-REFERENCE TO RELATED APPLICATION

This application claims priority to and the benefit of Korean Patent Application No. 10-2023-0154862 filed in the Korean Intellectual Property Office on Nov. 9, 2023, the entire contents of which are incorporated herein by reference.

### BACKGROUND

### (a) Technical Field

The present disclosure relates to soft magnetic alloy powder and an electronic component including the same.

### (b) Description of the Related Art

Recently, a power supply voltage has been lowered due to miniaturization and high integration of electronic devices, and accordingly, a current value has increased to transmit the same power. Accordingly, metal inductors that maintain inductor performance even at high currents have been applied, but recently, materials having high current characteristics, that is, high saturation magnetic flux density, have been applied among metals for use at higher currents.

Accordingly, soft magnetic materials having improved miniaturization and high-frequency characteristics have been developed, and recently, Fe—Co alloys have come to prominence. Fe—Co alloys, having a higher magnetic moment than Fe-based alloys, have a high saturation magnetic flux density, and when the Fe—Co alloys have a high saturation magnetic flux density, a change in inductance is low at large currents, which is advantageous for miniaturization of components.

However, Fe—Co alloys have a high loss compared to Fe-based alloys, so although Fe—Co alloys have high saturation magnetic flux density characteristics, application thereof to small electronic components is limited.

### SUMMARY

The present disclosure attempts to provide a soft magnetic alloy power particle having excellent loss characteristics, while having a high saturation magnetic flux density.

Another aspect of the embodiment provides an electronic component including the soft magnetic alloy powder.

However, the problems to be solved by the embodiments are not limited to the aforementioned problems and may be expanded in various manners within the scope of the technical ideas included in the embodiments.

According to an embodiment, a soft magnetic alloy powder includes: a core including an amorphous phase Fe—Co alloy or a Fe—Co alloy including a mixture including an amorphous phase and a nanocrystalline phase; and a first coating layer disposed to surround the core and including a Co oxide, wherein Co is included in an amount of 5 atom % to 25 atom % in the entire Fe—Co alloy, and an amorphous rate of the soft magnetic alloy powder is 95% or more.

The amorphous rate of the soft magnetic alloy powder may be 98% or more.

An average thickness of the first coating layer may be 4 nm to 50 nm.

The core may further include at least one selected from niobium (Nb), copper (Cu), phosphorus (P), and alloys thereof.

The soft magnetic alloy powder may further include a second coating layer disposed to surround the first coating layer.

The second coating layer may include at least one selected from Al, Si, Zr, Zn, Mg, P, Fe, Cr, and oxides thereof.

An average thickness of the second coating layer may be 10 nm to 30 nm.

According to another embodiment, an electronic component includes: a body including a magnetic material including soft magnetic alloy particle; a coil disposed within the body; and an external electrode disposed on an outer surface of the body and connected to the coil,

wherein the soft magnetic alloy particle includes a core including an amorphous phase Fe—Co alloy or a Fe—Co alloy including a mixture including an amorphous phase and a nanocrystalline phase, and a first coating layer disposed to surround the core and including a Co oxide,

wherein Co is included in an amount of 5 atom % to 25 atom % in the entire Fe—Co alloy, and

The amorphous rate of the soft magnetic alloy particle may be 95% or more.

The amorphous rate of the soft magnetic alloy particle may be 98% or more.

An average thickness of the first coating layer is 4 nm to 50 nm.

The core may further include at least one selected from niobium (Nb), copper (Cu), phosphorus (P), and alloys thereof.

The soft magnetic alloy particle may further include a second coating layer disposed to surround the first coating layer.

The coil may include a support member and a first coil and a second coil respectively disposed on a first surface and a second surface of the support member, and the first coil and the second coil may be connected through a via penetrating through the support member.

The body may include a mold portion; a cover portion disposed on one surface of the mold portion; and a core protruding from one surface of the mold portion, the coil may be disposed between one surface of the mold portion and the cover portion, and the core may penetrate through the coil.

The body may include a plurality of magnetic sheets including the magnetic material.

The soft magnetic alloy powder according to an embodiment has the advantage of having a high saturation magnetic flux density and excellent loss characteristics.

However, the various and beneficial advantages and effects of the present disclosure are not limited to the aforementioned content, and may be more easily understood in the process of explaining specific embodiments of the present disclosure.

### BRIEF DESCRIPTION OF THE DRAWINGS

FIG. 1 is a cross-sectional view schematically illustrating a soft magnetic alloy powder according to an embodiment.

FIG. 2 is a transparent perspective view of an electronic component according to an embodiment.

FIG. 3 is a schematic cross-sectional view taken along line I-I′ in FIG. 2.

FIG. 4 is an enlarged view of region A in FIG. 3.

FIG. 5 is a transparent perspective view of an electronic component according to another embodiment.

FIG. 6 is a schematic cross-sectional view taken along line II-II′ in FIG. 5.

FIG. 7 is a transparent perspective view of an electronic component according to another embodiment.

FIG. 8 is a schematic cross-sectional view taken along line III-III′ in FIG. 7.

### DETAILED DESCRIPTION

Hereinafter, embodiments of the present disclosure will now be described more fully hereinafter with reference to the accompanying drawings so that they may be easily implemented by one of ordinary skill in the art. The drawings and description are to be regarded as illustrative in nature and not restrictive. Like reference numerals designate like elements throughout the specification. The accompanying drawings of the present disclosure aim to facilitate understanding of the present disclosure and should not be construed as limited to the accompanying drawings. Also, the present disclosure is not limited to a specific disclosed form, but includes all modifications, equivalents, and substitutions without departing from the scope and spirit of the present disclosure. In the accompanying drawings, some of the elements in the accompanying drawings are exaggerated, omitted, or schematically illustrated, and the size of each element does not entirely reflect the actual size.

In addition, unless explicitly described to the contrary, the word “comprise”, and variations, such as “comprises” or “comprising”, will be understood to imply the inclusion of stated elements but not the exclusion of any other elements.

Throughout the specification, a ‘stacking direction’ refers to a direction in which components are sequentially laminated, may also be a ‘thickness direction’ perpendicular to a large surface (a main surface) of sheet-shaped components, and corresponds to a T-axis direction. Also, a ‘side’ refers to a direction extending parallel to the large surface (the main surface) from the edge of the sheet-shaped component, which may be a ‘plane direction’, and corresponds to an L-axis direction in the drawing. Also, a W-axis direction may be the ‘width direction’.

Hereinafter, various embodiments and modifications will be described in detail with reference to the drawings.

### Soft Magnetic Alloy Powder

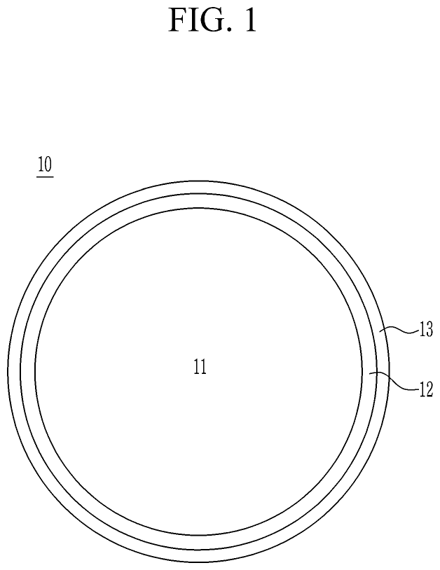

FIG. 1 is a cross-sectional view schematically illustrating a soft magnetic alloy powder 10 according to an embodiment.

Referring to FIG. 1, the soft magnetic alloy powder 10 according to an embodiment includes a core including an amorphous phase Fe—Co alloy or a Fe-—Co alloy in which an amorphous phase and a nanocrystalline phase are mixed and a first coating layer 12 disposed to surround the core 11 and including a Co oxide.

An amorphous rate of the soft magnetic alloy powder 10 according to an embodiment is 95% or more.

As an example, the amorphous rate of the soft magnetic alloy powder 10 may be 98% or more, 99% or more, or 99.5% or more. As a specific example, the amorphous rate of the soft magnetic alloy powder 10 may be 100%, and in this case, the soft magnetic alloy powder 10 may not include a nanocrystal grain phase.

If the amorphous rate of the soft magnetic alloy powder 10 is less than 95%, it may be difficult to efficiently improve loss characteristics of the soft magnetic alloy.

The amorphous rate (%) of the soft magnetic alloy powder 10 may be calculated using Equation 1 below.

$$Amorphous rate ( \% ) = [ Ia / ( Ic + Ia ) ] \times 100 \qquad [ Equation 1 ]$$

In Equation 1, Ic is the sum of integral values of scattering intensity of a crystalline peak in an X-ray diffraction analysis spectrum of the soft magnetic alloy powder, and Ia is the sum of integral values of scattering intensity of an amorphous halo in the X-ray diffraction analysis spectrum of the soft magnetic alloy powder.

The amorphous rate of the soft magnetic alloy powder may be calculated based on a graph obtained by X-ray diffraction spectroscopy. In the X-ray diffraction analysis spectrum, a relationship of 2d·sin θ=nλ is established between a wavelength λ and incidence angle θ of an incident X-ray and a lattice spacing d, and this relationship is called the Bragg equation. Accordingly, once the incidence angle is determined, the lattice spacing d may be obtained.

However, in amorphous materials, a random arrangement, rather than a regular atomic arrangement, appears, so multiple X-ray diffraction does not appear at a specific wavelength and a wide halo pattern appears in a region in which the diffraction angle is 35° to 55°. If there is no peak that appears at a specific angle in a diffraction angle range of 40° to 50° and a diffuse halo pattern appears, it may be determined to be an amorphous material having an amorphous rate of 100%. However, a surface of the soft magnetic alloy powder exposed to X-rays should not include any contaminants other than organic substances. Reliability is high as long as the results are measured under conditions where there are no factors affecting a diffraction pattern.

If crystals exist in the soft magnetic alloy powder, one or more crystalline peaks exist in the measured diffraction angle range. The existence of a peak refers to a case in which, in an XRD pattern graph, in an X-ray diffraction diagram in which a maximum intensity in the range of diffraction angle 2θ=40° to 50° is an entire plane of a vertical axis, a peak is recognized at least with the naked eye or a waveform processing device clearly distinguishes a peak from background noise.

At this time, if the amorphous rate is low, the halo region is reduced, and in a material having an amorphous rate of 0%, the halo region does not exist. If crystalline and amorphous are mixed, the amorphous rate may be calculated by calculating a relative ratio of a region of a crystalline peak and an area of the halo region in a graph including an intensity and diffraction angle range.

A method of measuring the amorphous rate of the soft magnetic alloy powder 10 included in the electronic component 100 according to an embodiment is as follows.

First, after the electronic component 100 is introduced into an epoxy mixture and cured, side surfaces of the electronic component body 110 in the L-axis direction and T-axis direction are polished to a ½ point in the W-axis direction, fixed, and then maintained in a vacuum atmosphere chamber to prepare a cross-sectional sample cut in the L-axis direction and the T-axis direction from the center of the body 110 in the W-axis direction.

Next, the cross-sectional sample may be pulverized to about 20 um or more and classified, and an XRD graph of the soft magnetic alloy powder may be obtained through the obtained sample, and then the amorphous rate may be obtained through Equation 1 above. Other methods and/or tools appreciated by one of ordinary skill in the art, even if not described in the present disclosure, may also be used.

### Core

The core 11 is a portion including a material having magnetic properties, and includes an amorphous phase iron (Fe)-cobalt (Co) alloy or an iron (Fe)-cobalt (Co) alloy in which an amorphous phase and a nanocrystal grain phase are mixed.

In an embodiment, the core 11 may further include the Fe—Co alloy, boron (B), niobium (Nb), copper (Cu), phosphorus (P), carbon (C), alloys thereof, or combinations thereof.

In an embodiment, the core 11 may include a metal having a lower ionization tendency than cobalt (Co). For example, the core 11 may not include or may be free of silicon (Si).

For example, with respect to the entire core 11, Fe may be included by 60 atom % or more, or 63 atom % or more, and may be included by less than 80 atom %, or 76 atom % or less.

For example, with respect to the entire core 11, Co may be included in the amount of 4 atom % or more, 8 atom % or more, or 10 atom % or more, and may be included by 25 atom % or less, 20 atom % or less, or 15 atom % or less.

When the content (atom %) of Fe and Co for the entire core 11 satisfies the above numerical range, an electronic component having a high saturation magnetic flux density may be implemented.

For example, B may be included in an amount of 10 to 15 atom % in the entire core 11.

For example, with respect to the entire core 11, Nb may be included in the amount of 0.2 atom % to 1 atom %.

For example, with respect to the entire core 11, Cu may be included in the amount of 0.2 atom % to 1 atom %.

For example, with respect to the entire core 11, P may be included in the amount of 1 to 5 atom %.

For example, with respect to the entire core 11, C may be included in the amount of 1 to 2 at %.

In an embodiment, with respect to the entire Fe—Co alloy, Co is included in the amount of 5 to 25 at %.

For example, with respect to the entire Fe—Co alloy, Co may be included in the amount of 5 atom % to 20 atom %, or 9 atom % to 20 atom %. When the above numerical range is satisfied, an electronic component having high saturation magnetic flux density may be implemented.

A method of measuring the content (atom %) of components included in the soft magnetic alloy powder used in the electronic component 100 according to an embodiment is as follows.

First, a preprocessed sample is prepared by dissolving and diluting a cross-sectional sample of the electronic component 100 in an acidic solution. For the preprocessed sample, the content ratio of each element present in the sample may be measured through ICP-OES (Inductively Coupled Plasma Optical Emission Spectrometer) analysis, a trace element analysis method. The content ratios of the measured elements may be converted into atom % of each element and used. Other methods and/or tools appreciated by one of ordinary skill in the art, even if not described in the present disclosure, may also be used. As an example, the core 11 may further include Ni, Ag, Sn, As, Sb, Bi, N, O, S, or combinations thereof.

### First Coating Layer

The first coating layer 12 is arranged to surround the core 11 and includes a Co oxide.

The first coating layer 12 may be a layer formed to surround the core 11 by oxidizing cobalt (Co), which has the highest ionization tendency among metals included in the core 11.

In the soft magnetic alloy powder 10 according to an embodiment, since the core 11 does not include Si, the first coating layer 12 may include a Co oxide, rather than a Si oxide. Accordingly, the soft magnetic alloy powder 10 includes a metal oxide layer having a sufficient thickness and has sufficiently high resistivity, so that loss characteristics of the electronic component may be efficiently improved.

When the core 11 includes silicon (Si), Si, which has a higher ionization tendency than Co, is oxidized first, and accordingly, a Si oxide coating layer may be formed on the surface of the core 11. Since Si may only be dissolved in Fe at a maximum of about 6 wt %, the thickness of the Si oxide coating layer being formed may be limited to about 5 nm or less. Accordingly, it is difficult to secure an oxide coating layer having a sufficient thickness and it is difficult to improve the resistivity of the soft magnetic alloy powder, so there is a limit to improving the loss characteristics of electronic components.

In addition, if the core 11 does not include both Si and Co, Fe may oxidize first, forming an Fe oxide coating layer on the surface of the core 11. Since the Fe oxide coating layer may be formed in various forms, such as FeO, Fe₂O₃, or Fe₃O₄, a change in volume of the coating layer is large, so a large number of voids may be formed in the coating layer. In this case, forming an additional coating layer on the outside may cause the Fe oxide coating layer to separate or inhibit the additional coating layer from contacting the Fe oxide coating layer. Accordingly, magnetic properties, such as permeability and loss characteristics, of the electronic component may be significantly reduced.

In an embodiment, an average thickness of the first coating layer 12 may be 4 nm to 50 nm. For example, the average thickness of the first coating layer 12 may be 4 nm or more, 10 nm or more, or 20 nm or more, and may be 50 nm or less, 45 nm or less, or 40 nm or less.

When an average thickness of the first coating layer 12 satisfies the above range, the surface of the core may include the metal oxide layer having a sufficient thickness and the resistivity is sufficiently high, so the loss characteristics of the electronic component may be efficiently improved.

The average thickness of the first coating layer 12 may be measured as follows.

A thin sample having a size of about 2 μm is manufactured from the center of a cross-section sample of the electronic component described above using a focused ion beam (FIB), and a transmission electron microscopy (TEM) analysis is performed on the sample. At this time, the thin sample should not include a coil and should include one or more soft magnetic alloy powders 10.

The core 11, the first coating layer 12, and the second coating layer 13, which will be described below, may be identified by distinguishing portions different in light and dark by, for example, binarizing the TEM image of the thin sample from each other.

The thickness of the first coating layer 12 is measured by measuring from the surface of one soft magnetic alloy powder 10 observed in the TEM image of the thin sample to about 200 nm toward the center of the soft magnetic alloy powder 10.

Then, the average thickness of the first coating layer 12 may be obtained as an arithmetic average value of three values measured from any three points of one soft magnetic alloy powder or as an arithmetic average value of total nine values measured from any three points of three different soft magnetic alloy powders. Other methods and/or tools appreciated by one of ordinary skill in the art, even if not described in the present disclosure, may also be used.

### Second Coating Layer

The soft magnetic alloy powder 10 according to an embodiment may further include a second coating layer 13 disposed to surround the first coating layer 12.

The second coating layer 13 is a coating layer for providing insulation properties and securing inductance between the soft magnetic alloy powders 10, and unlike the first coating layer 12, the second coating layer 13 may not affect the resistivity of the soft magnetic alloy powder 10 itself.

The second coating layer 13 is disposed to surround the first coating layer 12 and, for example, may be located at the outermost portion of the soft magnetic alloy powder 10. The second coating layer 13 may be arranged as one or more layers, and may be arranged as up to three layers.

As an example, the second coating layer 13 may include an organic layer, an inorganic layer, or combinations thereof.

The organic layer may include an epoxy resin, a polyimide resin, a liquid crystal polymer, or combinations thereof.

The inorganic layer may include at least one selected from Al, Si, Zr, Zn, Mg, P, Fe, Cr, and oxides thereof.

As an example, the inorganic layer may include alumina (Al₂O₃), silica (SiO₂), silicon oxide (SiO), zirconia (ZrO₂), zinc oxide (ZnO), magnesium oxide (MgO), phosphorus oxide (P₂O₅), and iron oxide (FeO), chromium oxide (CrO), or combinations thereof.

As a specific example, the second coating layer 13 may include Al₂O₃—P₂O₅—ZnO or SiO₂.

When the second coating layer 13 is the metal oxide, the second coating layer 13 may include a metal element included in the soft magnetic alloy powder 10.

A thickness of the second coating layer 13 may be 1% to 20% of a particle diameter of the soft magnetic alloy powder 10.

If the thickness of the second coating layer 13 exceeds 20% of the particle diameter of the soft magnetic alloy powder 10, magnetic permeability and magnetic susceptibility may be reduced, so it is desirable to make the thickness as thin as possible.

For example, the average thickness of the second coating layer 13 may be 10 nm to 30 nm. The average thickness of the second coating layer 13 may be measured in the same manner as the average thickness of the first coating layer 12 described above. Other methods and/or tools appreciated by one of ordinary skill in the art, even if not described in the present disclosure, may also be used.

### Electronic Component

Hereinafter, an example of an electronic component 100 including a magnetic material including the soft magnetic alloy powder 10 described above will be described. Types of the electronic components may include thin film-type electronic components, multilayer-type electronic components, wound-type electronic components, or coiled electronic components. In the following, thin film-type electronic components will first be described. The electronic component may be an inductor, capacitor, piezoelectric element, varistor, or thermistor, and a specific example may be an inductor.

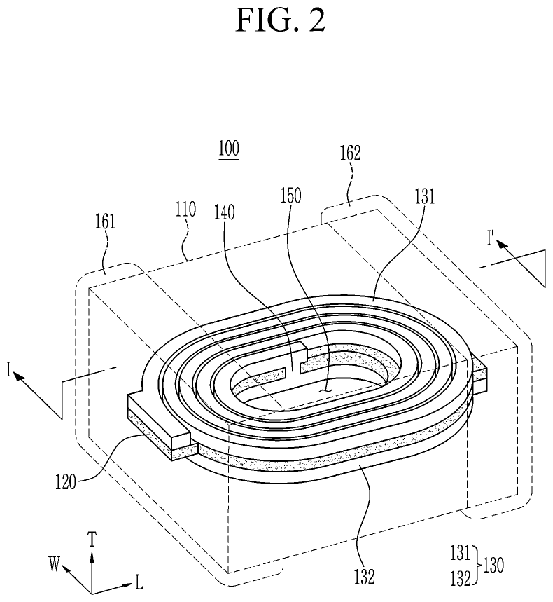

FIG. 2 schematically shows a transparent perspective view of a thin film-type electronic component 100 according to an embodiment.

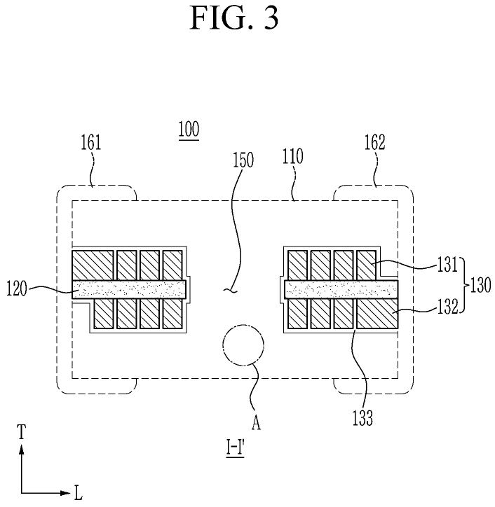

FIG. 3 schematically shows a cut surface taken in the direction I-I′ in FIG. 2 and schematically shows a cross-sectional view of the thin film-type electronic component 100 shown in FIG. 2.

The thin film-type electronic component 100 according to an embodiment includes a body 110 including a magnetic material including the soft magnetic alloy powder 10; a coil 130 disposed within the body; and external electrodes 161 and 162 disposed on an outer surface of the body 110 and connected to the coil 130.

The body 110 forms the exterior of the thin film-type electronic component 100.

The body 110 may have a hexahedral shape including upper and lower surfaces facing in a stacking direction of the coil, side surfaces facing each other laterally, and a front surface facing in a width direction, and the lower surface (the other surface) of the body when mounted on a printed circuit board may be a mounting surface. The corners at which each side meets may be rounded by grinding, etc.

The body 110 may be formed by forming the coil 130, stacking sheets including magnetic material on upper and lower portions of the coil 130, and then pressing and curing the sheets.

The body 110 includes a magnetic material, and the magnetic material includes the soft magnetic alloy powder 10 according to an embodiment.

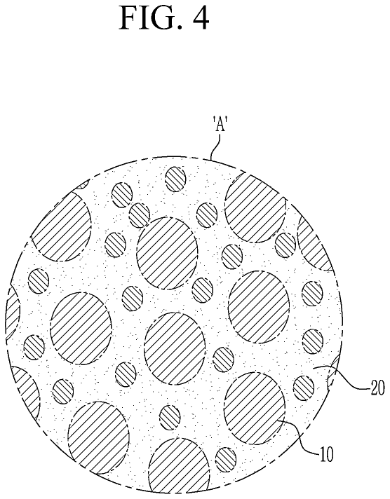

FIG. 4 is an enlarged view of region A in FIG. 3.

Referring to FIGS. 3 and 4, the magnetic material may include a resin 20 and the soft magnetic alloy powder 10 dispersed in the resin. As an example, the soft magnetic alloy powder 10 may be dispersed using the resin 20 as a matrix.

Referring to FIG. 4, the soft magnetic alloy powder 10 may be a coarse particle having an average particle diameter of 5 μm to 30 μm or a fine particle having an average particle diameter of 1 μm to 10 μm. As a specific example, the soft magnetic alloy powder 10 may be a coarse particle having an average particle diameter of 5 μm to 30 μm.

The average particle diameter of the soft magnetic alloy powder 10 present in the body 110 may be measured from a cross-section of the body 110. Specifically, with respect to a cross-section in the L-T direction passing through the center of the body 110, a plurality of regions (e.g., 10 regions) at equal intervals in the T-axis direction are imaged with a scanning electron microscope, and then a particle diameter of the magnetic alloy powder may be obtained using an image analysis program. Other methods and/or tools appreciated by one of ordinary skill in the art, even if not described in the present disclosure, may also be used. In this case, since magnetic particles may be deformed or destroyed in an outer region of the body 110 due to a compression process, etc., the particle diameter of the soft magnetic alloy powder may be measured excluding the outer region. For example, a region corresponding to a length within 5% or 10% of the surface of the body 110 may be excluded.

In addition to the soft magnetic alloy powder 10, the magnetic material may further include a ferrite material.

The ferrite may include known ferrites, such as Mn—Zn-based ferrite, Ni—Zn-based ferrite, Ni—Zn—Cu-based ferrite, Mn—Mg-based ferrite, Ba-based ferrite, or Li-based ferrite.

The resin may be an insulating resin and may include, but is not limited to, an epoxy resin, a polyimide resin, a liquid crystal polymer, or combinations thereof.

Since the soft magnetic alloy powder 10 is the same as that described above, the redundant description will be omitted.

The coil 130 is disposed within the body 110 and serves to exhibit the characteristics of the electronic component. For example, when the electronic component 100 is used as a power electronic component (e.g., a power inductor), the coil may serve to stabilize power of the electronic device by storing an electric field as a magnetic field and maintaining an output voltage. The coil may be of a winding type formed by a winding method, a thin film type formed by a thin film method, or a lamination type formed by a lamination method, and hereinafter, a thin film type coil will be described as an example.

The coil 130 may include the upper coil 131 and the lower coil 132 disposed on the upper and lower surfaces of the support member 120, respectively. The upper coil 131 and the lower coil 132 may be coil layers arranged to face each other with respect to the support member 120.

The upper coil 131 and the lower coil 132 may be formed as plating layers on the support member 120 by a plating process or a photo lithography method.

The coil 130 is formed of a material having excellent electrical conductivity, for example, one selected from gold (Au), silver (Ag), platinum (Pt), copper (Cu), nickel (Ni), palladium (Pd), and aluminum (Al).), titanium (Ti), etc., or alloys thereof, but any conventional conductive material may be used without limitation.

The material or type of the support member 120 is not particularly limited as long as it may support the upper coil 131 and the lower coil 132 and may be, for example, copper clad laminate (CCL), polypropylene glycol (PPG), a substrate, a ferrite substrate, or a metallic soft magnetic substrate. In addition, it may be an insulating substrate formed of an insulating resin. As insulating resins, a thermosetting resin, such as an epoxy resin, a thermoplastic resin, such as polyimide, or a resin impregnated with a reinforcing material, such as glass fiber or an inorganic filler, for example, prepreg, Ajinomoto build-up film (ABF), FR-4, a bismaleimide triazine (BT) resin, a photo imagable dielectric (PID) resin, etc. may be used. From the viewpoint of maintaining rigidity, an insulating substrate including glass fiber and an epoxy resin may be used, but is not limited thereto.

A central portion of the upper and lower surfaces of the support member 120 may be penetrated to form a hole, and the hole may be filled with a magnetic material to form the core portion 150. Inductance may be improved by forming the core portion filled with the magnetic material.

The upper coil 131 and the lower coil 132 laminated on both surfaces of the support member are electrically connected through a via 140 penetrating through the support member 120.

The via 140 may be formed by forming a through-hole using a mechanical drill or laser drill, and then filling the inside of the through-hole with a conductive material through plating.

The shape or material of the via 140 is not particularly limited as long as it may electrically connect the upper coil 131 on the upper side and the lower coil 132 on the lower side respectively disposed on both surfaces of the support member 120. Here, the upper and lower sides are determined based on the stacking direction of the coil patterns in the drawing.

The via 140 may include a conductive material, such as copper (Cu), aluminum (AI), silver (Ag), tin (Sn), gold (Au), nickel (Ni), lead (Pd), or alloys thereof.

The upper and lower coils 131 and 132 may be covered with an insulating layer 133 and may not be in direct contact with the magnetic material forming the body 110.

The insulating layer 133 serves to protect the upper and lower coils 131 and 132.

The material of the insulating layer 133 may be any material that contains an insulating material and may include, for example, an insulating material used in general insulating coatings, for example, an epoxy resin, a polyimide resin, a liquid crystalline polymer resin, etc., and a known PID resin, etc. may be used, but it is not limited thereto.

The insulating layer 133 may be formed by a method, such as vapor deposition, but is not limited thereto, and may be formed by laminating an insulating film on both surfaces of the support member.

The electronic component 100 according to an embodiment includes external electrodes 161 and 162 electrically connected to the upper and lower coils 131 and 132 and disposed on an outer surface of the body 110.

The external electrodes 161 and 162 are electrically connected to the lead terminals of the upper and lower coils 131 and 132 exposed to both side surfaces of the body 110, respectively.

The external electrodes 161 and 162 serve to electrically connect the coil 130 within the electronic component to an electronic device when the electronic component 100 is mounted on the electronic device.

The external electrodes 161 and 162 may be formed using a conductive paste including a conductive metal, and the conductive metal may be at least one of copper (Cu), nickel (Ni), tin (Sn), and silver (Ag) or alloys thereof.

The external electrodes 161 and 162 may include a plating layer formed on the paste layer.

The plating layer may include one or more selected from the group consisting of nickel (Ni), copper (Cu), and tin (Sn), and for example, a nickel (Ni) layer and a tin (Sn) layer being formed sequentially.

Hereinafter, a winding-type electronic component 200 and a lamination-type electronic component 300 will be described in detail. Hereinafter, only the differences of the winding-type electronic component 200 and the lamination-type electronic component 300 from those of the thin film-type electronic component 100 will be described. For the other components, the description of the thin film-type electronic component 100 may be applied as is.

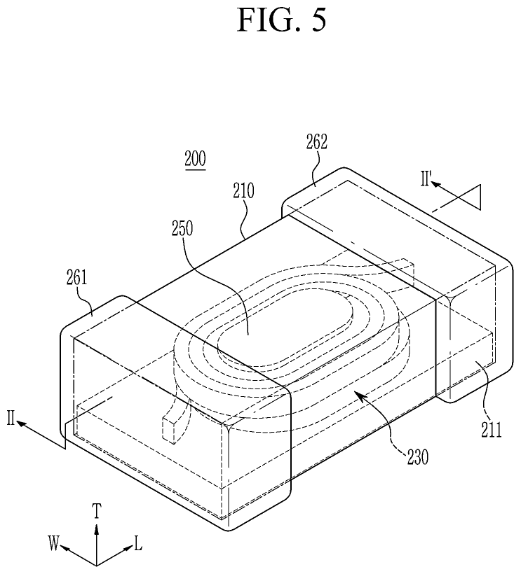

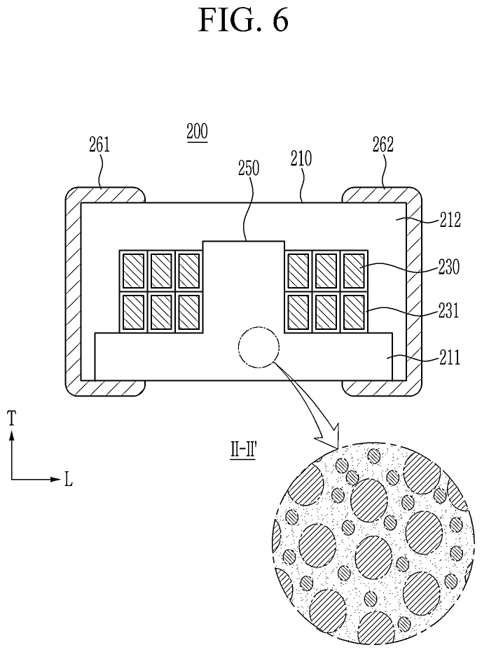

FIG. 5 is a transparent perspective view of a winding-type electronic component according to another embodiment, and FIG. 6 is a schematic cross-sectional view taken along line II-II' in FIG. 5, which is a schematic cross-sectional view of the electronic component shown in FIG. 5.

The winding-type electronic component 200 according to an embodiment includes a body 210 including a magnetic material including a soft magnetic alloy powder, a coil 230 disposed within the body, and external electrodes 261 and 262 disposed on an outer surface of the body 210.

In an embodiment, the body 210 includes a mold portion 211, a cover portion 212 disposed on one surface of the mold portion 211, and a core 250 protruding from one surface of the mold portion 212, the coil 230 is disposed between one surface of the mold portion 211 and the cover portion 212, and the core 250 penetrates through the coil 230.

The body 210 of the winding-type electronic component 200 may include the mold portion 211 and the cover portion 212 disposed on one surface of the mold portion 211 and may further include the core 250 disposed to protrude from one surface of the mold portion 211. At this time, the coil 230 may be disposed on one surface of the mold portion 211, and the coil 230 may have a shape surrounding the core 250.

The body 210 includes a magnetic material, and the magnetic material includes a soft magnetic alloy powder according to an embodiment. That is, at least one of the mold portion 211, the cover portion 212, and the core 250 includes a magnetic material including the soft magnetic alloy powder. As an example, the mold portion 211 may be formed by filling a mold with a magnetic material. As another example, the mold portion 211 may be formed by filling a mold with a composite material including a magnetic material and a resin. A process of applying high temperature and high pressure to the magnetic material or composite material in the mold may be additionally performed, but is not limited thereto. The mold portion 211 and the core 250 may be integrally formed by the aforementioned mold, so that no boundary is formed therebetween. The cover portion 212 may be formed by disposing a magnetic composite sheet in which a magnetic material is dispersed in a resin on the mold portion 211 and the coil 230 and then heating and pressing the magnetic composite sheet.

In the winding-type electronic component 200, a lead portion (not shown) may penetrate through the mold portion 211 and be connected to the external electrodes 261 and 262.

The description of the thin film-type electronic component 100 according to an embodiment may be equally applied to the description of the magnetic material and soft magnetic alloy powder in the body 210.

In the winding-type electronic component 200, a surface of the coil 230 may be covered by an insulating layer 231, and the insulating layer 231 may function to insulate between the magnetic material of the body 210 and the coil 230. The description of the insulating layer 133 given above may be equally applied to the insulating layer 221.

Compared to the thin film-type electronic component 100, the winding-type electronic component 200 has differences in the configuration of the coil 230 and the presence or absence of a support member.

The coil 230 is of the winding type and does not include a support member. The coil 230 may be a winding coil formed by winding a metal wire, such as a copper wire (Cu-wire) including a metal line and an insulating layer 221 covering a surface of the metal line. The metal wire may be a rectangular wire, but is not limited thereto.

In FIG. 5, the coil 230 is shown as an alpha (α) type winding, but this is merely an example, and the coil 230 may be an edge-wise winding.

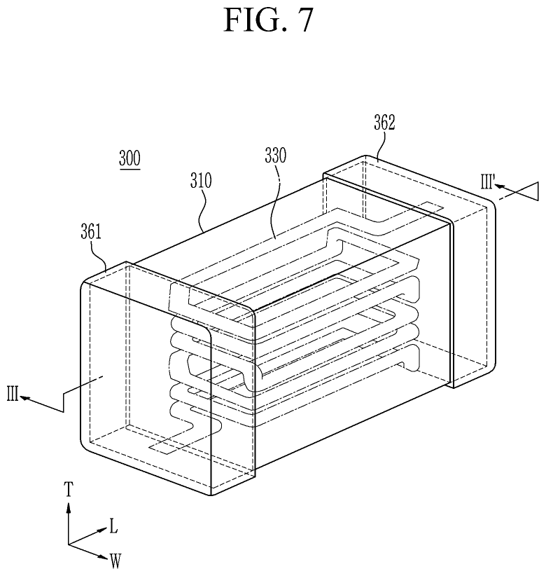

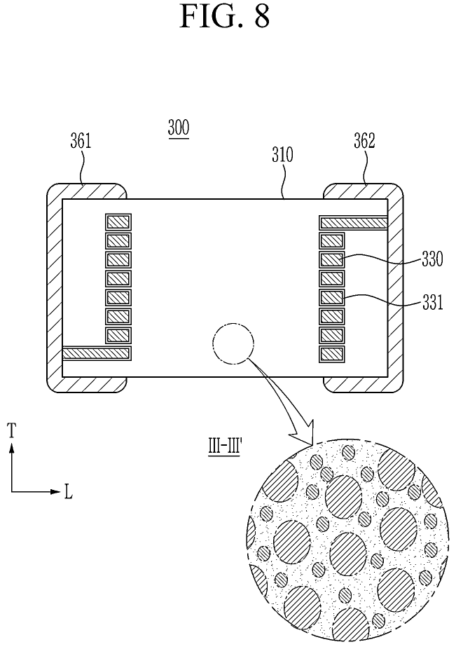

FIG. 7 is a schematic transparent perspective view of a lamination-type electronic component according to another embodiment, and FIG. 8 is a schematic cross-sectional view taken along line III-III′ in FIG. 7, which is a schematic cross-sectional view of the electronic component shown in FIG. 7.

The lamination-type electronic component 300 according to an embodiment includes a body 310 including a magnetic material including a soft magnetic alloy powder, a coil 330 disposed within the body, and external electrodes 361 and 362 disposed on an outer surface of the body 310, and the body 310 includes a plurality of magnetic sheets including the magnetic material.

The description of the thin film-type electronic component 100 according to an embodiment may be equally applied to the description of the magnetic material and soft magnetic alloy powder in the body 310.

As an example, the body 310 is formed by stacking a plurality of magnetic sheets including a magnetic material in the thickness direction and then firing the same. The shape, dimensions, and number of laminated magnetic sheets of the body 310 are not limited to those illustrated in the embodiment.

A conductive pattern for forming the coil 330 may be formed on one surface of the plurality of magnetic sheets, and a conductive via may be formed in a penetrating manner in the thickness direction of the magnetic sheet to electrically connect conductive patterns located above and below.

Accordingly, one end of the conductive pattern formed on each magnetic sheet is electrically connected to each other through a conductive via formed in an adjacent magnetic sheet to form the coil 330.

A surface of the coil 330 may be covered with an insulating layer 331, and the insulating layer 331 may function to insulate between the magnetic material of the body 310 and the coil 330. The description of the insulating layer 133 given above may be equally applied to the insulating layer 331.

Both ends of the coil 330 may be drawn out through the body 310 and contact and are electrically connected to a pair of external electrodes 361 and 362 formed on the body 310, respectively.

In particular, both ends of the coil 330 may be drawn out through both ends of the body 310, and the pair of external electrodes 361 and 362 may be formed on both ends of the body 310 from which the coil 330 is drawn out.

The conductive pattern may be formed by applying a conductive paste for forming a conductive pattern to a green sheet for forming the magnetic sheet through thick film printing, application, deposition, sputtering, etc. but is not limited thereto.

The conductive via may be formed by forming a through-hole in the thickness direction of each sheet and then filling the through-hole with a conductive paste, but is not limited thereto.

In addition, the conductive metal included in the conductive paste for forming the conductive pattern may be one of silver (Ag), palladium (Pd), platinum (Pt), nickel (Ni), and copper (Cu) or alloys thereof, but the present disclosure is not limited thereto.

Due to the excellent properties, the soft magnetic alloy powder may be included in the body of thin film-type, the winding-type, or the lamination-type electronic components as described above, thereby improving electromagnetic properties and maintaining high saturation magnetization characteristics.

In addition to the electronic components described above, the soft magnetic alloy powder may also be used in magnetic products, such as transformers, motors, or stators of motors.

Hereinafter, specific embodiments of the disclosure are presented. However, the examples described below are only for illustrating or explaining the disclosure in detail and should not limit the scope of the disclosure.

### EXAMPLE

### Preparation Example 1: Preparation of Soft Magnetic Alloy Powder

Fe, Co, B, Nb, Cu, P, and C raw materials were prepared, and the prepared raw materials were weighed to include atom % as shown in Table 1 The weighed raw materials were mixed and a base alloy was below. manufactured using arc melting. The prepared base alloy was melted and then rapidly cooled in a rapid cooling facility to prepare an initial soft magnetic alloy.

The initial soft magnetic alloy was heat-treated to prepare soft magnetic alloy powders of Examples 1 to 11 and Comparative Examples 1 to 6, which had the compositions shown in Table 1 below.

In addition, the sum of the atom % of Fe and Co is expressed as the atom % of the Fe-Co alloy with respect to the entire core, and the Co content with respect to the entire Fe-Co alloy is shown in Table 1 below.

### Preparation Example 2: Manufacturing of Inductor

A body including a magnetic material in the form of a soft magnetic alloy powder prepared in Preparation Example 1 dispersed in a resin was manufactured, and an inductor including the body was manufactured.

TABLE 1

| | Composition (atom %) | | | | | | | | | |
|---|---|---|---|---|---|---|---|---|---|---|
| | | | | | | | | | Atom % of | Atom % of Co |
| | | | | | | | | | Fe—Co | with respect |
| | | | | | | | | | alloy with | to entire |
| | | | | | | | | | respect to | Fe—Co |
| | Fe | Co | Si | B | Nb | Cu | P | C | entire core | alloy |
| Example 1 | 68 | 14 | 0 | 10 | 0.5 | 0.5 | 5 | 2 | 82 | 17.1 |
| Example 2 | 71 | 8 | 0 | 13 | 0.5 | 0.5 | 5 | 2 | 79 | 10.1 |
| Example 3 | 73 | 8 | 0 | 11 | 0.5 | 0.5 | 5 | 2 | 81 | 9.9 |
| Example 4 | 63 | 19 | 0 | 10 | 0.5 | 0.5 | 5 | 2 | 82 | 23.2 |
| Example 5 | 76 | 4 | 0 | 12 | 0.5 | 0.5 | 5 | 2 | 80 | 5.0 |
| Example 6 | 67 | 10 | 0 | 15 | 0.5 | 0.5 | 5 | 2 | 77 | 13.0 |
| Example 7 | 68.3 | 14 | 0 | 10 | 0.2 | 0.5 | 5 | 2 | 82.3 | 17.0 |
| Example 8 | 67.5 | 14 | 0 | 10 | 1 | 0.5 | 5 | 2 | 81.5 | 17.2 |
| Example 9 | 70 | 14 | 0 | 10 | 0.5 | 0.5 | 3 | 2 | 84 | 16.7 |
| Example 10 | 72 | 14 | 0 | 10 | 0.5 | 0.5 | 1 | 2 | 86 | 16.3 |
| Example 11 | 69 | 14 | 0 | 10 | 0.5 | 0.5 | 5 | 1 | 83 | 16.9 |
| Comparative | 80 | 0 | 0 | 12 | 0.5 | 0.5 | 5 | 2 | 80 | 0.0 |
| Example 1 | | | | | | | | | | |
| Comparative | 55 | 27 | 10 | 10 | 0.5 | 0.5 | 5 | 2 | 82 | 32.9 |
| Example 2 | | | | | | | | | | |
| Comparative | 68 | 16 | 10 | 8 | 0.5 | 0.5 | 5 | 2 | 84 | 19.0 |
| Example 3 | | | | | | | | | | |
| Comparative | 62 | 10 | 0 | 20 | 0.5 | 0.5 | 5 | 2 | 72 | 13.9 |
| Example 4 | | | | | | | | | | |
| Comparative | 73 | 14 | 0 | 10 | 0.5 | 0.5 | 0 | 2 | 87 | 16.1 |
| Example 5 | | | | | | | | | | |
| Comparative | 70 | 14 | 10 | 10 | 0.5 | 0.5 | 5 | 0 | 84 | 16.7 |
| Example 6 | | | | | | | | | | |

### EVALUATION EXAMPLE

### Evaluation Example 1: Evaluation of Amorphicity and Crystallinity

After the inductor prepared in Preparation Example 2 was introduced into an epoxy mixture and cured, the side surfaces of the inductor in the L-axis direction and T-axis direction were polished to a 1/2 point in the W-axis direction, and then fixed and maintained in a vacuum atmosphere chamber to prepare a cross-sectional sample cut in the L-axis direction and T-axis from the center of the inductor in the W-axis direction.

Thereafter, the cross-sectional sample was pulverized to about 20 μm or more and classified to obtain an XRD graph of the soft magnetic alloy powder, and then an amorphous rate was calculated using Equation 1 below.

$$Amorphous rate ( \% ) = [ Ia / ( Ic + Ia ) ] \times 100 \qquad [ Equation 1 ]$$

In Equation 1, Ic is the sum of integral values of scattering intensity of a crystalline peak in an X-ray diffraction analysis spectrum of the soft magnetic alloy powder, and Ia is the sum of integral values of scattering intensity of an amorphous halo in the X-ray diffraction analysis spectrum of the soft magnetic alloy powder.

A calculated amorphous rate of 95% or more is indicated as ‘amorphous’, and a calculated amorphous rate less than 95% is indicated as ‘crystalline’ and shown in Table 2 below.

### Evaluation Example 2: Type and Average Thickness of First Coating Layer

A thin sample having a size of about 2 μm was manufactured from the center of a cross-section sample manufactured in Evaluation Example 1 using a focused ion beam (FIB), and a transmission electron microscopy (TEM) analysis was performed on the sample.

First, the types of materials constituting the first coating layer were identified through TEM-EDS analysis, and are shown in Table 2 below.

In addition, the thickness of the first coating layer 12 was measured by measuring from the surface of one soft magnetic alloy powder 10 observed in the TEM image of the thin sample to about 200 nm toward the center of the soft magnetic alloy powder 10. Next, an arithmetic average of three values measured from any three points in one soft magnetic alloy powder was calculated to be an average thickness of the first coating layer, and is shown in Table 2 below.

### Evaluation Example 3: Loss Characteristics Evaluation

The soft magnetic alloy powder prepared in Preparation Example 1 was sieved to have an average particle diameter of about 15 μm, and then mixed with carbonyl iron powder (CIP) having an average particle diameter of about 1.5 μm at an 8:2 ratio. 0.3 wt % of binder was mixed with the mixed powder and then manufactured as granular powder.

The granular powder was charged into a toroidal mold, molded at a pressure of 1.5 ton/cm² for about 30 seconds, and cured at about 150° C. for 1 hour to prepare a sample for measurement.

A loss (mW/cc) of the sample for measurement was measured at 5 points in the 0.5 to 1.5 MHz band based on 1 MHz under the condition of b=20 mT using a B-H analyzer (SY-8218, IWATSU), and the loss (mW/cc) is shown in Table 2 below.

TABLE 2

| | | First coating layer | | |
|---|---|---|---|---|
| | Amorphicity/ | | Average | Loss |
| | Crystallinity | Composition | thickness | (mW/cc) |
| Example 1 | amorphous | Co oxide | 40 nm | 220 |
| Example 2 | amorphous | Co oxide | 25 nm | 270 |
| Example 3 | amorphous | Co oxide | 30 nm | 310 |
| Example 4 | amorphous | Co oxide | 39 nm | 230 |
| Example 5 | amorphous | Co oxide | 5 nm | 280 |
| Example 6 | amorphous | Co oxide | 32 nm | 260 |
| Example 7 | amorphous | Co oxide | 37 nm | 254 |
| Example 8 | amorphous | Co oxide | 36 nm | 218 |
| Example 9 | amorphous | Co oxide | 42 nm | 245 |
| Example 10 | amorphous | Co oxide | 38 nm | 260 |
| Example 11 | amorphous | Co oxide | 29 nm | 255 |
| Comparative | crystalline | Fe oxide | 10 nm | 400 |
| Example 1 | | | | |
| Comparative | crystalline | Co oxide | 20 nm | 440 |
| Example 2 | | | | |
| Comparative | crystalline | Co oxide | 16 nm | 402 |
| Example 3 | | | | |
| Comparative | amorphous | Co oxide | 30 nm | 404 |
| Example 4 | | | | |
| Comparative | crystalline | Co oxide | 14 nm | 330 |
| Example 5 | | | | |
| Comparative | crystalline | Co oxide | 13 nm | 304 |
| Example 6 | | | | |

Referring to Table 2, it can be seen that the soft magnetic alloy powder included in the inductors of Examples 1 to 11 had an amorphous rate of 95% or more, and the first coating layer included a Co oxide, and an average thickness thereof was 4 nm to 50 nm. Accordingly, it can be seen that, since the loss value of the soft magnetic alloy powder included in the inductors of Examples 1 to 11 was 310 mW/cc or less, which was very low compared to the comparative examples, the loss characteristics were significantly improved.

Although the embodiment of the present disclosure has been described above, the present disclosure is not limited thereto, and it is possible to carry out various modifications within the claim coverage, the description of the disclosure, and the accompanying drawings, and such modifications also fall within the scope of the present disclosure.

What is claimed is:

1. A soft magnetic alloy powder comprising:
a core including an amorphous phase Fe—Co alloy or a Fe—Co alloy including a mixture including an amorphous phase and a nanocrystalline phase; and
a first coating layer disposed to surround the core and including a Co oxide,
wherein Co is included in an amount of 5 atom % to 25 atom % in the entire Fe—Co alloy, and
an amorphous rate of the soft magnetic alloy powder is 95% or more.

2. The soft magnetic alloy powder of claim 1, wherein:
the amorphous rate of the soft magnetic alloy powder is 98% or more.

3. The soft magnetic alloy powder of claim 1, wherein:
an average thickness of the first coating layer is 4 nm to 50 nm.

4. The soft magnetic alloy powder of claim 1, wherein:
the core further includes at least one selected from niobium (Nb), copper (Cu), phosphorus (P), and alloys thereof.

5. The soft magnetic alloy powder of claim 1, further comprising:
a second coating layer disposed to surround the first coating layer.

6. The soft magnetic alloy powder of claim 5, wherein:
the second coating layer includes at least one selected from Al, Si, Zr, Zn, Mg, P, Fe, Cr, and oxides thereof.

7. The soft magnetic alloy powder of claim 5, wherein:
an average thickness of the second coating layer is 10 nm to 30 nm.

8. The soft magnetic alloy powder of claim 3, wherein:
the core further includes at least one selected from niobium (Nb), copper (Cu), phosphorus (P), and alloys thereof.

9. The soft magnetic alloy powder of claim 3, further comprising:
a second coating layer disposed to surround the first coating layer.

10. The soft magnetic alloy powder of claim 9, wherein:
the second coating layer includes at least one selected from Al, Si, Zr, Zn, Mg, P, Fe, Cr, and oxides thereof.

11. The soft magnetic alloy powder of claim 9, wherein:
an average thickness of the second coating layer is 10 nm to 30 nm.

12. An electronic component comprising:
a body including a magnetic material including soft magnetic alloy particle;
a coil disposed within the body; and
an external electrode disposed on an outer surface of the body and connected to the coil,
wherein the soft magnetic alloy particle includes a core including an amorphous phase Fe—Co alloy or a Fe—Co alloy including a mixture including an amorphous phase and a nanocrystalline phase, and a first coating layer disposed to surround the core and including a Co oxide,
wherein Co is included in an amount of 5 atom % to 25 atom % in the entire Fe—Co alloy, and
an amorphous rate of the soft magnetic alloy particle is 95% or more.

13. The electronic component of claim 12, wherein:
the amorphous rate of the soft magnetic alloy particle is 98% or more.

14. The electronic component of claim 12, wherein:
an average thickness of the first coating layer is 4 nm to 50 nm.

15. The electronic component of claim 12, wherein:
the core further includes at least one selected from niobium (Nb), copper (Cu), phosphorus (P), and alloys thereof.

16. The electronic component of claim 12, wherein:
the soft magnetic alloy particle further includes a second coating layer disposed to surround the first coating layer.

17. The electronic component of claim 14, wherein:
the core further includes at least one selected from niobium (Nb), copper (Cu), phosphorus (P), and alloys thereof.

18. The electronic component of claim 14, wherein:
the soft magnetic alloy particle further includes a second coating layer disposed to surround the first coating layer.

19. The electronic component of claim 12, wherein:
the coil includes a support member and a first coil and a second coil respectively disposed on a first surface and a second surface of the support member, and
the first coil and the second coil are connected through a via penetrating through the support member.

20. The electronic component of claim 12, wherein:
the body includes a mold portion; a cover portion disposed on one surface of the mold portion; and a core protruding from one surface of the mold portion, and
the coil is disposed between one surface of the mold portion and the cover portion, and the core penetrates through the coil.

21. The electronic component of claim 12, wherein:
the body includes a plurality of magnetic sheets including the magnetic material.

22. The electronic component of claim 12, wherein the core may be free of silicon (Si), and the soft magnetic alloy powder has an average particle diameter of 5 μm to 30 μm.
